(19) United States
(12) Patent Application Publication
(10) Pub. No.: US 2006/0103046 A1
(43) Pub. Date: May 18, 2006

(54) Method for melt-spinning polyester microfilaments having a maximum dtex of 0.7 and polyester microfilaments that can be produced according to this method

(76) Inventors: Ulrich B. Kemp, Domat/Ems (CH); Werner Stibal, Chur (CH)

Correspondence Address: BROWDY AND NEIMARK, P.L.L.C.;624 NINTH STREET, NW, SUITE 300, WASHINGTON, DC, 20001-5303, US

(21) Appl. No.: 10/522,141

(22) PCT Filed: Jul. 23, 2003
(86) PCT No.: PCT/CH03/00498

§ 371 Date: Sep. 13, 2005

(30) Foreign Application Priority Data
Jul. 24, 2002 (CH) 1300/02

(51) Int. Cl. B29C 41/24

(52) U.S. Cl. 264/165

(57) ABSTRACT

The invention relates to a method for melt-spinning polyester microfilaments having a maximum dtex of 0.7 and to microfilaments that can be produced according to this method. According to the invention, the filaments, according to their titer, are spun from a melt with a solution viscosity lower than that of the prior art.

The present invention concerns a method for the melt spinning of polyester microfilaments with a titre of not more than 0.7 dtex and the polyester microfilaments manufactured thereby.

According to the state of the art, in filament melt spinning a polymer melt is delivered to the spinneret plates from an extruder or from a polycondensation plant by spinning pumps. After emerging of the melt from the capillary bores of the spinneret plates in the form of fine filaments, these filaments are cooled by means of a cooling system, for example, by blowing with air, then combined, bundled, subjected to spinning preparation and, if occasion arises, wound at very high speeds, for example, at more than 2000 m/min.

For more than 10 years in polymer spinning technology a development has been emerging for the manufacture of filament yarns with finer and finer single-filament titres, so-called microfilaments with titres of less than 1 dtex.

The usual microfilament yarns for further processing of textiles are, according to the present-day state of the art, preferably composed of more than 100 single filaments.

Products of so many microfilaments are distinguished by special properties which are advantageous to the consumer.

For anyone skilled in the art, the melt spinning of microfilaments is not by any means trivial. Exit of the polymer melt from the fine nozzle bores and cooling of the filaments are very important steps in the process, because their uniformity very substantially affects the mass uniformity, the textile properties such as strength and elongation and particularly the uniformity and quality of dyeing of the microfilaments and of the yarns assembled therefrom.

Thus, constant temperature control in the high-viscosity polymer melt with little material flow up to the spinneret plate and through the capillary bores poses considerable problems for extremely fine filament titres. At excessively high spinning temperatures the polymers degrade all the faster, lower temperatures lead to greater irregularities among the filaments of the same spinneret plate and increased breaks of individual filaments or of the whole filament bundle upon exit from the spinneret plate.

According to the state of the art, polymers having melt viscosities which lie outside the range of so-called spinning grades cannot be spun.

For polyethylene terephthalate these are, for example, between 130 and 150 Pa·s 290° C., which corresponds to relative solution viscosities (1.0% in m-cresol at 20° C.) from eta rel. 1.60 to 1.65.

For the present invention, the object was therefore to provide a method for the melt spinning of polyester microfilaments with titres of less than 1.0 dtex, which with spinning performance allows the manufacture of filaments and the filament yarns assembled therefrom with very uniform textile properties and above all with particularly uniform dyeing.

This object is achieved by the method for the melt spinning of polyester microfilaments with a titre of not more than 0.7 dtex.

Surprisingly, in spinning tests it turned out that polyester microfilaments can, unlike the state of the art known hitherto, perfectly well be spun at lower viscosities than correspond to the so-called spinning grades for filament spinning.

It even proved particularly advantageous for the spinning performance of such microfilaments with titres of less than 0.7 dtex if the polymer melt has a reduced relative solution or melt viscosity compared with the usual spinning grades.

Thus in particular for polyethylene terephthalate a clear correlation can be formulated between filament titres of between 0.1 and 0.7 dtex and the viscosity, whereby the spinning performance is excellent and the dye ability of the microfilaments and of the filament yarns assembled therefrom is outstanding.

According to the formula:
(0.1052×InX)+1.649=eta rel.
polyethylene terephthalate microfilaments within the range between 0.1 and 0.7 dtex can be spun without problems, the spinning speed being 2500 m/min±10% and the resulting breaking elongation (BE) of the POY filaments being between 95 and 120%. Here, X stands for the filament titre (DTY titre) in dtex, and the relative solution viscosity eta rel. is measured 1% in m-cresol at 20° C.

Defined filament titres can easily be spun at the calculated viscosities with a breadth of fluctuation of relative solution viscosity of about ±0.05 still with the same good results at a defined spinning speed of 2500 m/min, for example.

Within this relationship it is possible, for example, to spin microfilaments with a titre of 0.34 dtex from polyethylene terephthalate with a relative solution viscosity eta rel. around 1.53, those of 0.23 dtex with eta rel. around 1.49 and of 0.1 dtex with eta rel. around 1.41.

The reduced polyethylene terephthalate viscosities thus used for the melt spinning of microfilaments are therefore advantageously within an eta rel. range of approx. 1.40 to 1.59.

By the process according to the invention, microfilaments with a titre of not more than 0.7 dtex can be spun, preferably those with titres of between 0.1 and 0.35 dtex and particularly preferably between 0.1 and 0.2 dtex, wherein as a particular advantage the total spin breaks which are known for microfilament spinning due to the tearing of all the filaments at the spinneret plate are absent within all titre ranges.

The relative solution or melt viscosities can be directly predetermined by polycondensation or the spinning granulate. They can be adjusted equally advantageously by adding additives which selectively lower the viscosity, to the polymer melt or to the spinning granulate in the extruder.

Basically, spinning speed of between 2000 and 3300 m/min can also be used for the aforementioned titre range, wherein adapted viscosities can be used for optimising of the spinning performance and uniformity of dyeing.

In an advantageous manner, diols are suitable as additives, and in a particular manner even alcohols or water.

Among the diols, ethylene glycol, diethylene glycol and particularly triethylene glycol are preferred.

For instance, triethylene glycol is added to the polyethylene terephthalate melt in quantities from 0.1 to 0.4 wt. % in order to obtain relative solution viscosities within the range from 1.4 to 1.59.

The invention also includes polyester microfilaments with a titre of not more than 0.7 dtex which can be manufactured by the method according to the invention and which are distinguished by a grey scale value for uniformity of dyeing from 4.5 to 5.0. This uniformity of dyeing is of particular value for textile further processing of the microfilaments according to the invention and of the filament yarns assembled therefrom, as it is well known to anyone skilled in the art that even in case of high uniformity of the textile properties according to the common Uster values U and U1/2 marketable yarns can still exhibit lack of uniformity of dyeing which is obtrusive in further processing.

To determine the uniformity of dyeing of the microfilaments, microfilament yarns in a knitted hose were dyed with a test dye and measured in a spectral photometer, and the L,a,b values determined.

In the process, samples which were taken from different spinning locations of a semi-industrial plant over 24 hours yielded results with excellent delta E values which without exception were below 1.0 and preferably below 0.9.

By the method according to the invention, the microfilaments can also be spun-dyed in a preferred manner.

The microfilaments according to the invention are suitable for further drawing and for thermal and/or mechanical treatment, for example, for spinning/drawing/texturing. They can also be further processed into highly oriented filament yarns.

Examples 1a to 1d illustrate the invention:

### EXAMPLES

“Method for the Melt Spinning of Polyester Microfilaments with a Titre of not more than 0.7 dtex and Polyester Microfilaments Manufactured Thereby”

| | | | | | |
|---|---|---|---|---|---|
| Total titre | dtex | 88.0 | 88.0 | 56.0 | 56.0 |
| Single filament | dtex | 0.46 | 0.46 | 0.29 | 0.29 |
| titre | | | | | |
| Spinning speed | m/min | 2500 | 2500 | 2500 | 2500 |
| Melting point | ° C. | 295 | 295 | 295 | 295 |
| Chips viscosity | m- | 1.640 | 1.640 | 1.640 | 1.640 |
| | cresol | | | | |
| Reduced vis- | m- | 1.510 | 1.560 | 1.470 | 1.630 |
| cosity | cresol | | | | |
| TEG addition | % | 0.20 | 0.10 | 0.31 | — |
| Spin perfor- | | very good | good | very good | not |
| mance | | | | | spinnable |

POY Data:

| | | | | | |
|---|---|---|---|---|---|
| Uster ½ | U % | 0.27 | 0.36 | 1.1 | — |
| Uster | U % | 0.45 | 0.67 | 2.4 | — |
| Tenacity | cN/dtex | 2.6 | 2.8 | 2.3 | — |
| Elongation | % | 105 | 98.0 | 117 | — |

DTY Data:

| Spinning/drawing/texturing | | very good | good | good | — |
|---|---|---|---|---|---|
| Single filament titre | dtex | 0.34 | 0.34 | 0.23 | — |
| Total titre | dtex | 65.4 | 65.8 | 43.2 | — |
| Tenacity | cN/dtex | 3.3 | 3.3 | 2.7 | — |
| Elongation | % | 23.3 | 23.1 | 24.5 | — |
| Boiling water shrinkage | % | 4.2 | 4.1 | 2.1 | — |

Colour Assessment:

| | | | | |
|---|---|---|---|---|
| Grey scale | 5 | 4 | 6 | — |
| HunterLabb | −33.8 | −32.4 | −30.6 | — |
| SDEV(b) | 0.12 | 0.19 | 0.35 | — |
| delta E max | 0.4 | 0.5 | 1.0 | — |

1. Process for the melt spinning of PES microfilaments with a titre of not more than 0.7 dtex,
characterised in that
the microfilaments are spun as partially oriented yarn (POY) at spinning speeds from 2250 to 3300 m/min from the melt of a polyester with reduced relative solution viscosity compared with PES fibre spinning grades with relative solution viscosities of between 1.60 and 1.65 as a function of their titre, wherein the relative solution viscosity reduced as a function of titre is determined according to the formula
eta rel=(0.1052×InX)+1.649,
where X is the filament titre in dtex,
and wherein the spin performance of defined filament titres can be realised with a breadth of fluctuation of relative solution viscosity of ±0.05.

2. Process according to claim 1,
characterised in that
the polyester melt is polyethylene terephthalate.

3. (canceled)

4. Process according to claim 2, characterised in that the reduced relative solution viscosity of the polyethylene terephthalate melt is adjusted by adding and homogeneously mixing in at least one viscosity-regulating additive.

5. Process according to claim 4,
characterised in that the additive is selected from the group comprising aliphatic diols and water.

6. Process according to claim 5,
characterised in that the aliphatic diol is selected from the group comprising triethylene glycol, diethylene glycol and ethylene glycol.

7. Process according to claim 1,
characterised in that filaments with titres from 0.1 to 0.7 dtex are spun.

8. Process according to claim 7,
characterised in that filaments with titres from 0.1 to 0.35 dtex are spun.

9. Process according to claim 7,
characterised in that filaments with titres from 0.1 to 0.2 dtex are spun.

10. Polyester microfilaments with a titre of not more than 0.7 dtex, manufactured according to claim 1,
characterised in that they have a dyeing uniformity value according to grey scale from 4.0 to 5.0 and a delta E value of less than 1.0.
